(19) United States
(12) Patent Application Publication
(10) Pub. No.: US 2025/0077940 A1
(43) Pub. Date: Mar. 6, 2025

(54) SYSTEMS AND METHODS FOR DETECTING HALLUCINATIONS IN MACHINE LEARNING MODELS

(71) Applicant: Intuit, Inc., Mountain View, CA (US)

(72) Inventors: Wendi CUI, Jersey City, NJ (US); Colin P. RYAN, Tucson, AZ (US); Damien J. LOPEZ, San Diego, CA (US); Palak SAMEL, San Diego, CA (US); Joel D ATWOOD, San Diego, CA (US)

(21) Appl. No.: 18/241,135

(22) Filed: Aug. 31, 2023

(51) Int. Cl. G06N 20/00

(52) U.S. Cl. CPC G06N 20/00

(57) ABSTRACT

Certain aspects of the disclosure provide systems and methods for detecting hallucinations in machine learning models. A method generally includes generating a potential answer from an initial prompt received from a user. The method generally includes interrogating the machine learning model with a verification prompt formulated to elicit a positive or negative response from the machine learning model based on the potential answer and initial prompt. A negative response by the neural network model to the verification prompt is indicative of the potential answer being a hallucination. A positive response by the neural network model to the verification prompt is indicative of the potential answer being free from a hallucination. The method generally includes outputting to the user the potential answer as a final answer upon receiving a positive response to the verification prompt.

### BACKGROUND

### Field

Aspects of the present disclosure relate to machine learning models, such as large language models (LLMs), and more specifically, to systems and methods for detecting hallucinations in machine learning models.

### Description of Related Art

The use of machine learning models, especially LLMs such as ChatGPT and GPT4, by the general public is becoming widespread. While machine learning architectures, such as Generative Pre-trained Transformers (GPTs), hold great promise for improving outcomes and efficiencies across many applications, such as diagnostics, tax preparation, job searching, and finance, significant issues relating to the accuracy of the outputs of such models (e.g., answers to prompts) have quickly arisen. Within the context of LLM models, these occurrences of inaccurate or completely wrong answers are termed “hallucinations.” Perniciously, these hallucinations are often delivered as otherwise very convincing answers, and even when questioned, LLMs will double-down on the correctness of the hallucination. Often times these hallucinations can be attributed to data outside a specified set of data or even based on non-existent data that is essentially generated by the LLM in an effort to provide an answer to a query. Occurrences of hallucinations can be difficult for a user of the LLM to identify, especially a user that is not an expert in the particular field to which the answer is directed.

Several attempts have been made to identify the instances of hallucinations and mitigate their effects. For example, check-gpt utilizes a second neural network model, referred to as TruthChecker that is chained to the primary LLM (e.g., ChatGPT, for example). The check-gpt solution requires training of a second LLM, namely the TruthChecker model, to review the output of the first model. However, this can be costly in terms of resource needed for training, as well as for operating the second model.

There have been several high profile instances of hallucinations in neural networks that have caused significant problems. In one case, an attorney, used an LLM to prepare a legal brief. However, it was later found by the judge that the brief included several case citations generated by the LLM that were fictitious. In other cases, educators found that papers in which students used an LLM contain fictitious “facts”, including findings in non-existent research articles with non-existent authors.

Accordingly, improved techniques for identifying and reducing hallucinations in answers provided by LLMs are needed.

### SUMMARY

Certain aspects provide a method for detecting hallucinations output from a machine learning model. The method generally includes generating a potential answer from an initial prompt received from a user. The method generally includes interrogating the machine learning model with a verification prompt formulated to elicit a positive or negative response from the machine learning model based on the potential answer and initial prompt. A negative response by the neural network model to the verification prompt is indicative of the potential answer being a hallucination. A positive response by the neural network model to the verification prompt is indicative of the potential answer being free from a hallucination. The method generally includes outputting to the user the potential answer as a final answer upon receiving a positive response to the verification prompt.

Certain aspects provide a method for detecting hallucinations in a machine learning model. The method generally includes generating an initial prompt from a query provided by the user via the user interface and context data retrieved from a datastore. The method generally includes transmitting the initial prompt to the machine learning model to generate a potential answer. The method generally includes interrogating the machine learning model with a verification prompt formulated to elicit a positive or negative response from the machine learning model based on the potential answer and initial prompt. A negative response by the machine learning model to the verification prompt is indicative of the potential answer being a hallucination. A positive response by the machine learning model to the verification prompt is indicative of the potential answer being free from a hallucination. The method generally includes outputting to the user the potential answer as a final answer upon receiving a positive response to the verification prompt.

Certain aspects provide a system for detecting hallucinations in output from a machine learning model. The system generally includes an interface configured to accept queries. The system generally includes one or more memory comprising computer-executable instructions and a machine learning model. The system generally includes one or more processors configured to execute the computer-readable instructions and causes the system to generate a potential answer from an initial prompt, and interrogate the machine learning model with a verification prompt formulated to elicit a positive or negative response from the machine learning model based on the potential answer and initial prompt. A negative response by the machine learning model to the verification prompt is indicative of the potential answer being a hallucination. A positive response by the machine learning model to the verification prompt is indicative of the potential answer being free from a hallucination. The system generally includes an output device configured to present to the user the potential answer as a final answer upon receiving a positive response to the verification prompt.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 illustrates an example system configured for reducing hallucinations in query answers by a neural network model.

FIG. 2 illustrates a block representation of an example process for performing aspects of the present disclosure.

FIG. 3 illustrates a block representation of another example process for performing aspects of the present disclosure.

FIG. 4 illustrates a flow representation of an example method for performing aspects of the present disclosure.

FIGS. 5A and 5B illustrate a flow representation of another process for performing aspects of the present disclosure.

FIGS. 6A and 6B illustrate a flow representation of yet another process for performing aspects of the present disclosure.

FIG. 7 illustrates an example system on which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for identifying hallucinations generated by a machine learning model, such as an LLM. In some aspects, such hallucinations may be in the form of answers to a user-provided query that are either based on data outside a defined context or nonexistent data. Context encompasses all the sources of information that the model is instructed to use to generate an answer to the user-provided query. The sources of information may include journal articles, corporate databases, websites and any other sources of information relevant to the query. Thus, for a tax related question, the context may include documents published by the Internal Revenue Service, while a medical question may specify using articles from peer-reviewed medical journals as context. Once a hallucination is identified, aspects of the present disclosure may provide improvement prompts directed to providing an answer to the user-provided query that conforms to the requested context.

As an example, a user may request information on allowability of a particular tax deduction from an LLM model (or service hosting the model). In this example, the user instructs the LLM to limit its answer to be based on current national (U.S. Internal Revenue Service) and/or local (e.g., State Taxation Department) tax authorities' rules, regulations and other guidance from the relevant authorities. In a conventional scenario, the LLM would then provide an answer.

Whereas in this example the LLM was asked a question and instructed to use a limited number of documents that are of particular relevance to the question asked (e.g., a context), the LLM should ideally answer the question based solely on the defined context. However, often the LLM will provide an answer based on data outside the defined context, such as non-existent sources and data. Of course, the user can review the regulations themselves to verify that the LLM provided an accurate answer, but non-tax specialists may rightly feel uncomfortable and/or be unwilling to interpret the regulations to confirm the accuracy of the answer. That is, after all, the purpose of the LLM in this example. If the user has to expend time to verify an output of an LLM by, for example, reviewing the source documents, using the LLM becomes less appealing and less useful. Moreover, the complexity of prompts, the underlying context, and generating the right answers is such that it is completely impractical to perform manual (e.g., human) checking of answers at scale. For example, a query service based on an underlying LLM could not possibly perform the verification process using human minds.

Aspects of the present disclosure address the possibility of hallucinations by automatically verifying that model output from a machine learning model, such as from an LLM, is based on the provided or specified sources and data (e.g., context). Aspects of the present disclosure present a verification prompt to the machine learning model that includes a closed-ended query based on the initial query prompt and the answer output by the machine learning model. The verification prompt may, in some embodiments, ask if the previous answer was solely based on the context provided as part of the initial prompt to the machine learning model. The output answer from the machine learning model responsive to the verification prompt, in some embodiments, may be, for example, a “YES” or a “NO”, or other positive and negative indicia. In one example, an answer of “NO” indicates that the answer to the initial prompt may be a hallucination, while a “YES” answer would indicate that the answer to the initial prompt is not a hallucination.

Some embodiments described herein may include an improvement prompt as well. The improvement prompt may allow a fine tuning of the initial prompt to provide a more accurate response from the machine learning model with a reduced chance of hallucinations.

In some embodiments, the verification prompt and the improvement prompt may be repeated one or more times until the verification prompt returns a “YES” (or similar positive answer) indicating the answer to the user's question is not a hallucination.

Thus, embodiments described herein have the beneficial technical effect of providing an automated verification method for determining whether answers generated by a machine learning model are free of hallucinations. This overcomes the technical problem in the art of models producing hallucinations, and also provide a more computationally efficient technical solution as compared to training an entire additional model to perform the verification. In other words, beneficially, embodiments described herein use the existing machine learning model to determine whether its output is a hallucination, and thus do not require the physical (e.g., compute, memory, power, and time) and fiscal resources necessary to train and deploy separate verification models. Additionally, in some embodiments, when a hallucination is detected, an improved prompt may be utilized to reduce the chance of a hallucination in the output answer.

### Example Systems and Methods for Detecting Hallucinations in Machine Learning Models

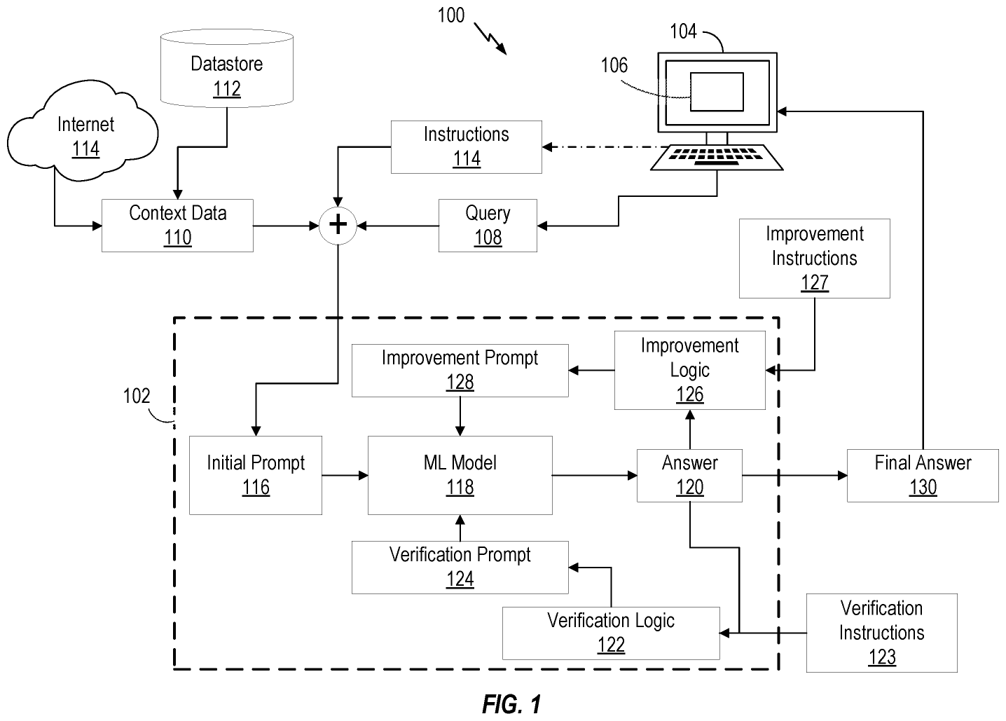

FIG. 1 illustrates a hallucination detection system 100 according to embodiments of the present disclosure. The hallucination detection system 100 includes a machine learning model server 102 (also referred to herein as “model server 102”) that provides a communication interface to a user device 104. The user device 104 can be a terminal workstation, a desktop computer, a mobile phone, a tablet computer, a laptop computer, an intelligent assistant device, or the like. The user device 104 may be connected to the model server 102 by way of the Internet 114, for example. In other embodiments, the user device 104 may be connected to the model server 102 by way of a local area network (LAN). Alternatively, other network schemes may be implemented between the user interface 106 and the model server 102.

In order to allow a user to interact with the model server 102, a user interface 106 is provided by the model server 102 to the user device 104. In some embodiments, the user interface 106 can be a webpage provided to the user device 104 via the Internet 114 or LAN, for example. The webpage-based user interface 106 may include graphical elements allowing the user to select and define certain parameters or constraints to which the final answer (i.e., final answer 130) from the model is to conform. The parameters and constraints collectively form instructions 114 for the model server 102. Additionally, the webpage-based user interface 106 may also include a text input field configured to accept a query 108 from the user in the form of a text string. Furthermore, the webpage-based user interface 106 may include a text output field configured to receive a final answer 130 from the model server 102.

In other embodiments, for example, where the user device 104 is an intelligent assistant device, the user interface 106 may be configured to provide an audio interface, in which the user may verbally ask a question as the query 108 to the model server 102. In response, the model server 102 may provide audio acknowledgements and prompts, when necessary, to elicit any additional instructions 114 for the final answer 130. The intelligent assistant may be configured to accept instructions 114 specifying which resources (e.g., articles, databases, websites, and other data) can be used to generate an answer. The specified resources represent context data 110. The user may be prompted to verbally indicate the level of complexity to which the final answer 130 is to conform.

In other embodiments, the user interface 106 may be provided as an application programming interface (API) through which developers can access the functionality of a machine learning model 118 (also referenced hereinafter as “model 118”) within a software application, such as a mobile application (or “app”), for example. The API may provide functions, classes, and/or objects for accepting a query input from a user, and set parameter values for constraining the final answer 130 output by the model. Model 118 may include one or more models accessible to the model server 102.

The context data 110, such as articles, databases, images, and other forms of appropriate data may be provided to the model server 102 from various sources, such as Internet 114 websites, and datastore 112, which is representative of, for example, cloud storage site(s) and file server(s). By specifying that the final answer 130 needs to be generated based only on the provided context data 110, the development of hallucinations in the model 118 should be limited somewhat. However, since model 118 has been known to generate output based on non-existent sources, even limiting the model 118 to a small controlled number of source data may, in some circumstances, not be enough to avoid hallucinations.

The query 108, context data 110, and instructions 114 are combined to form an initial prompt 116 by the model server 102. The initial prompt 116 provides all the necessary information for the model 118 to generate an answer 120 thereto. In this example, the answer 120 is not output as a final answer 130 until it has been verified to not contain hallucinations. For example, the model 118 receives the initial prompt 116 and proceeds to generate the answer to the query 108 based on the instructions 114 and the context data 110. The answer 120 is then provided to verification logic 122. The verification logic 122 formulates a verification prompt 124 based on the initial prompt 116 and the potential answer 120, and any subsequent prompts and answers forming a chat history.

In addition to the chat history, the verification prompt may be provided with a verification instruction 123. The verification instructions 123 direct the model 118 to perform the role of a “classifier” whose role is to classify whether the answer 120 is strictly derived from the context data 110. The verification instructions 123 may additionally provide guidance for the model 118 on what to consider, examples of accurate query-answer pairs and examples of incorrect (or hallucinated) query-answer pairs.

The verification prompt 124 may include a close-ended question, such as “was the answer provided only from the give context data?” The question presented to the model 118 as the verification prompt 124 limits the model 118 to a limited set of responses, such as positive or negative responses like “YES” or “NO.” A “YES” response to the verification prompt 124 is indicative of an answer free of hallucinations. Thus, the model server 102 presents the potential answer 120 as the final answer 130 to the user device 104 by way of the user interface 106.

However, the verification prompt 124 may alternatively yield a “NO” response from the model 118. In some embodiments, the model server 102, upon receipt of a negative (e.g., “NO”) response, may output to the user device 104 an error message indicating that the initial prompt 116, as formulated, did not yield a reliable answer, or some other similar message, by way of the user interface 106. Additionally, the model server 102 may provide further instructions for reformulating the query 108, instructions 114, and context data 110 in a manner that may provide a better outcome.

Throughout the disclosure a convention is used in which positive terms (e.g., YES, TRUE, etc.) are used to denote that the result of the verification prompt is indicative of an absence of hallucinations in the potential answer 120. On the other hand, negative terms (e.g., NO, FALSE, etc.) are used to denote that the result of the verification prompt is indicative of a presence of hallucinations in the potential answer 120. However, this convention is a result of the phrasing of the verification query, and thus, in some embodiments the verification query may be phrased in a manner that would elicit opposite responses in the presence of hallucinations, such that negative terms would indicate a lack of hallucinations and positive terms indicate a presences of hallucinations.

In other embodiments, rather than output the above error message, the model server 102 may include an improvement logic 126. The improvement logic 126 generates an improvement prompt based on the potential answer 120 and the initial prompt 116 (e.g., chat history). The improvement logic 126 performs adjustments to the initial prompt 116 to fine tune a set of improvement instructions 127, and outputs the result as the improvement prompt 128. The improvement prompt 128 is formulated in a manner intended to reduce the possibility of the model 118 hallucinating when generating a new potential answer 120. New verification prompts 124 and new improvement prompts 128 may be generate and presented to the machine learning model 118 until a verification prompt 124 results in an affirmative (e.g., “YES”) answer, which is indicative of the answer 120 from which the verification prompt 124 was generated is free of hallucinations. As described above, a “YES” verification answer causes the model server 102 to present the current potential answer 120 as the final answer 130 to the user device 104 by way of the user interface 106.

In embodiments of the present disclosure, the instructions 114 may provide the machine learning model 118 with information regarding the role the machine learning model 118 is performing. For example, the machine learning model 118 may be directed to act as an educator of a certain level, such as college professor, elementary school teacher, etc. Alternatively, the machine learning model 118 may be directed to act as a particular corporate position, e.g., human resource (HR) assistant, information technology (IT) professional, a doctor or nurse, etc. The assigned roles assist the machine learning model 118 in formulating and structuring the final answer 130 in a manner appropriate for the situation.

The instructions 114 may include directives to the machine learning model 118 that describe the level of detail a final answer 130 should have. For example, instructions 114 may direct that the final answer 130 be concise, limited to a particular word count, etc. Additionally, the tone of the final answer 130 may be specified. For example, the machine learning model 118 may be instructed to provide the final answer 130 in a friendly and positive tone, or in an objective, clinical tone, for example. An intellectual level of the final answer 130 may be specified as well. For example, the model may be instructed that the final answer 130 should be written at college level, high school level, novice level, expert level, etc. Further, the structure of the final answer 130 may also be specified, such as, provide key points in a bulleted list, presented with citations to the relevant sources, etc. The instructions 114 may also specify the format of the output, such as JSON format, for example.

As discussed above, the instructions 114 may also direct the machine learning model 118 to base its output on a particular set of source material as the context data 110. The source material may include particular databases, such as employee databases or inventory databases, for example. The source material may also be limited to specific journals and articles. The journals and articles may be provided by way of internal or external universal resource locators (URLs), for example. Alternatively, the specific articles may be provided directly to the model as part of the initial query 116, in the form of portable document format (PDF), for example.

Moreover, the instructions 114 may provide the machine learning model 118 with instructions on responding if an answer cannot be generated, for example if the provided context data 110 is insufficient or improper for generating an answer. For example, the machine learning model 118 may be instructed to respond with “I am sorry I do not have the information handy. Is there anything else I can help you with?”

In some embodiments, the instructions 114 are generated by the user through manipulation of various elements of the user interface 106. In other, embodiments, the instructions 114 are configured at the model server 102 and not changeable by the user, but may be changeable by an administrator or else someone with sufficient privileges. In still other embodiments, a portion of the instructions 114 are controllable by the user from the user interface 106, while other aspects of the instructions are set at the model server 102. For example, a user may be provided functionality in the user interface 106 to adjust the length of the final answer 130, but the role of the machine learning model 118 may be set at the model server 102 such that the machine learning model 118 may provide answers only in the role of an IT professional, for example.

Verification instructions 123 and improvement instructions 127, may be generated by the model server 102 without user interaction. Thus, the verification and improvement phases of the final answer generation may beneficially be performed in an automated fashion and hidden from the user.

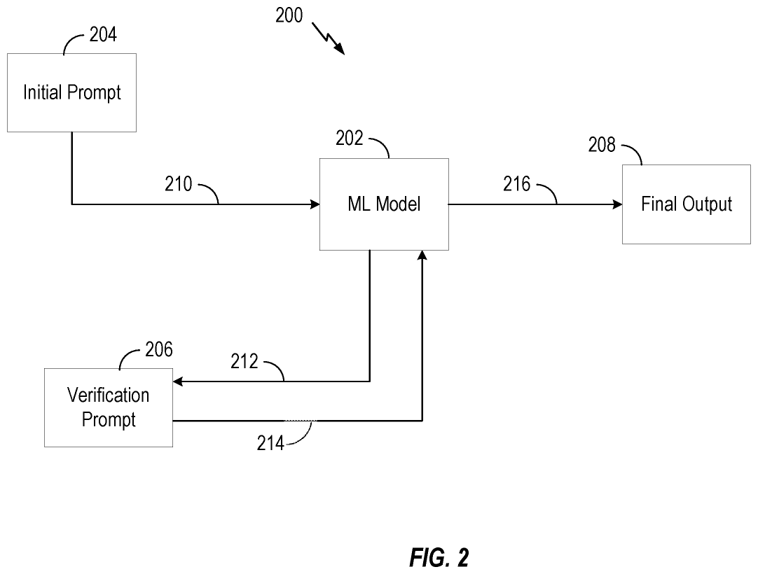

FIG. 2 illustrates a block representation providing an overview of a method 200 of an embodiment of the present disclosure. In FIG. 2 arrows 210, 212, 214, and 216 represent the direction of the data flow during execution of the method 200. In the present embodiment, a machine learning model 202 (hereinafter, also referenced as model 202) is configured to receive, via data flow 210, an initial prompt 204 from a user device, such as user device (104 in FIG. 1). The initial prompt 204 includes a query (108 in FIG. 1), a set of context data (110 in FIG. 1) and instructions (114 in FIG. 1) that are used by the model 202 to generate an output, such as final output 208. The output from the model 202, transmitted via data flow 212 to for example, the verification logic (e.g., 122 in FIG. 1), is used to generate a verification prompt 206. The verification prompt 206 is presented to the model 202 for evaluation via data flow 214. As described above with respect to FIG. 1, for example, the verification prompt 206 is generated from the output generated by the model 202 in response to the chat history. The verification logic 122, for example, generates a closed-ended query that forces the model 202 to respond with a positive or negative (e.g., “YES”/“NO” or “TRUE”/“FALSE”) answer. By limiting the model 202 to a binary choice as an answer, the probability of the model 202 responding to the verification prompt with a hallucination is very low. Additionally, verification instructions (123 in FIG. 1), provided to the model 202 in the verification prompt 206, direct the model to assume the role of an adversarial “classifier” as described above.

Thus, the response to the verification prompt 206 may be relied on as indicative of whether the output associated with the initial prompt 204 is based on a hallucination by the model 202. As a result of the verification prompt 206 response, the model may generate a final output 208, via data flow 216, to a user, providing an answer responsive to the initial prompt 204, if the verification indicates no hallucination, or an error message if the verification indicates a hallucination may be present. The error message may be a statement that the model 202 is not able to provide an answer. Alternatively, the error message may include instructions for formulating a new initial prompt 204.

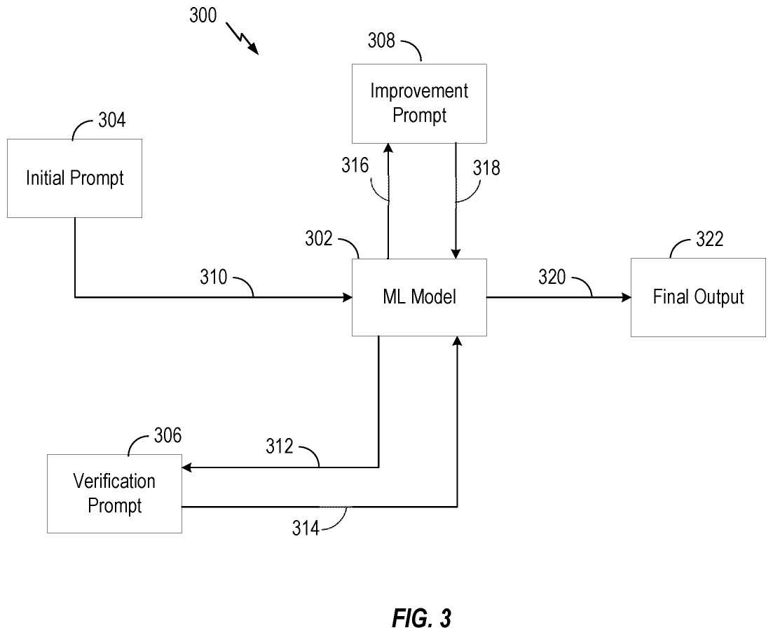

FIG. 3 illustrates a block representation providing an overview of a method 300 of another embodiment of the present disclosure. In FIG. 3 arrows 310, 312, 314, 316, and 318 represent the direction of the data flow during execution of the method 300. In method 300, a machine learning model 302 (hereinafter, also referenced as model 302) is configured to receive, via data flow 310, an initial prompt 304 from a user device, such as user device (e.g., 104 in FIG. 1). The initial prompt 304 includes a query (e.g., 108 in FIG. 1), a set of context data (e.g., 110 in FIG. 1) and instructions (e.g., 114 in FIG. 1) that are used by the model 302 to generate an output, such as final output 322. The output from the model 302, transmitted via data flow 312 to for example, the verification logic (e.g., 122 in FIG. 1), is used to generate a verification prompt 306. The verification prompt 306 is presented to the model 302 for evaluation via data flow 314. As described above with respect to FIG. 1, for example, the verification prompt 306 is generated from the output generated by the model 302 in response to the chat history. The verification logic 122, for example, a closed-ended query that forces the model 302 to respond with a positive or negative (e.g., “YES”/“NO” or “TRUE”/“FALSE”) answer. By limiting the model 302 to a binary choice as an answer, the probability of the model 302 responding to the verification prompt with a hallucination is very low. Additionally, verification instructions (e.g., 123 in FIG. 1), provided to the model 302 in the verification prompt 306, direct the model to assume the role of an adversarial “classifier” as described above.

The embodiment shown in FIG. 3 differs from the embodiment described with respect to FIG. 2, by the inclusion of an improvement prompt 308. The improvement prompt 308 is generated in response to a negative result to the verification prompt 306 indicating that a hallucination occurred in the output of model 302. In an example, the improvement logic (e.g., 126 in FIG. 1) may receive the negative result of the verification prompt 306 via data flow 316 from the model 302. As described above with respect to FIG. 1, for example, the improvement prompt 308 is formulated to elicit an answer to the original user question free of hallucinations. The improvement prompt 308 may include a different set of instructions (e.g., improvement instructions 127 in FIG. 1) from the ones provided in either the initial prompt 304 or the verification prompt 306. The improvement prompt 308 may direct the model 302 to operate in a different role, for example. The improvement prompt 308 is provided to the model 302 for processing via data flow 318.

New verification prompts 306 and improvement prompts 308 may be submitted to the model 302 in an iterative process until the model 302 returns a response to the verification prompt 306 indicating a hallucination-free answer has been obtained. At this point, the model 302 may generate a final output 322, via data flow 320, to a user, providing an answer responsive to the initial prompt 304.

In some embodiments, the iterative verification and improvement process may terminate even without achieving a hallucination-free answer if a timed-out condition is reached. The timed-out condition may define a length of time, such as 5 minutes for example. Once the reiterative exceeds the set time (e.g., 5 minutes) the model 302 terminates the process and outputs an error message to the user. Alternatively, the timed-out condition may be based on the number of iterations performed by the model 302. The error message may be a statement that the model 302 is not able to provide an answer.

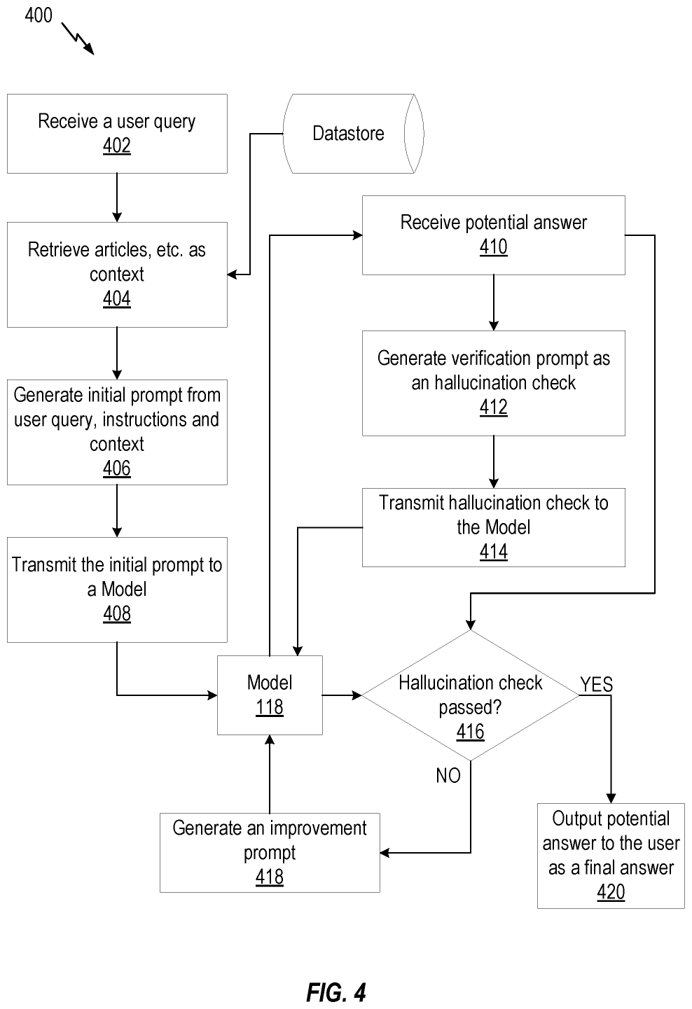

FIG. 4 illustrates a flow representation of an example method 400 for detecting the presence of hallucinations in an output (e.g., final answer) of a machine learning model (e.g., 118 in FIG. 1). The method 400 begins once a user's query (e.g., 108 in FIG. 1) is received at step 402. As described above, the query 108 may be submitted via a user interface (106 in FIG. 1) implemented on a user device (e.g., 104 in FIG. 1), such as, a terminal station, mobile device, desktop computer, laptop computer or tablet device, for example.

The model server (e.g., 102 in FIG. 1) retrieves articles and accesses databases as context data (e.g., 110 in FIG. 1) at step 404. The context data 110 may be retrieved from an intranet, Internet (e.g., 114 in FIG. 1) or local datastore (e.g., 112 in FIG. 1).

The method 400 generates an initial prompt (e.g., 116 in FIG. 1) from the query 108 provided by the user and context data 110 retrieved from the datastore 112, at step 406. The initial prompt 116 is transmitted, by the method 400, to a machine learning model (e.g., 118 in FIG. 1), at step 408. The model 118 generates a potential answer (e.g., 120 in FIG. 1) at step 410 in response to the initial query 116. The method 400 proceeds to step 412 where a verification prompt (e.g., 124 in FIG. 1) is formulated. As described above with respect to FIG. 1, the verification prompt 124 may be generated by a verification logic (e.g., 122 in FIG. 1) that combines a verification query with chat history, for example, a record of the initial prompt 116 and all previous potential answers 120, and a verification instructions (e.g., 123 in FIG. 1). The verification prompt 124 is formulated to elicit a “YES” or “NO” response from the model 118 based on the potential answer 120 and initial prompt 116.

The method 400 transmits the verification prompt 124 to the model 118 for processing at step 414. The model 118, in turn, processes the verification prompt 124 and outputs, at step 416, one of two possible answers, either a “NO” response or a “YES” response. A “NO” response (or other negative response) to the verification prompt 124 is indicative of the potential answer 120 being a hallucination, and thus, not responsive to the initial query 116. Alternatively, a “YES” response (or other positive response) to the verification prompt 124 is indicative of the potential answer 120 being responsive to the initial prompt 116, and thus, free of hallucinations. A “YES” response at step 416 causes the method 400 to proceed to step 420. At step 420, method 400 terminates by outputting, to the user, a final answer (e.g., 130 in FIG. 1) generated from the potential answer 120 determined to be responsive to the initial prompt 116.

However, a “NO” response at step 416 causes the method 400 to proceed to step 418 where an improvement prompt (e.g., 128 in FIG. 1) is generated. The improvement prompt 128 generated at step 418 is formulated to improve the performance of the model 118 by reducing the probability of a hallucination effecting a subsequent answer 120 to the initial prompt 116. The improvement prompt 128, generated by, for example, improvement logic (e.g., 126 in FIG. 1), includes the chat history and an improvement instruction (e.g., 127 in FIG. 1).

The method 400 repeats steps 410 through 418 until a potential answer 120 generated at step 410 is verified at step 416 to be free of hallucinations with a “YES” response to the verification prompt 124.

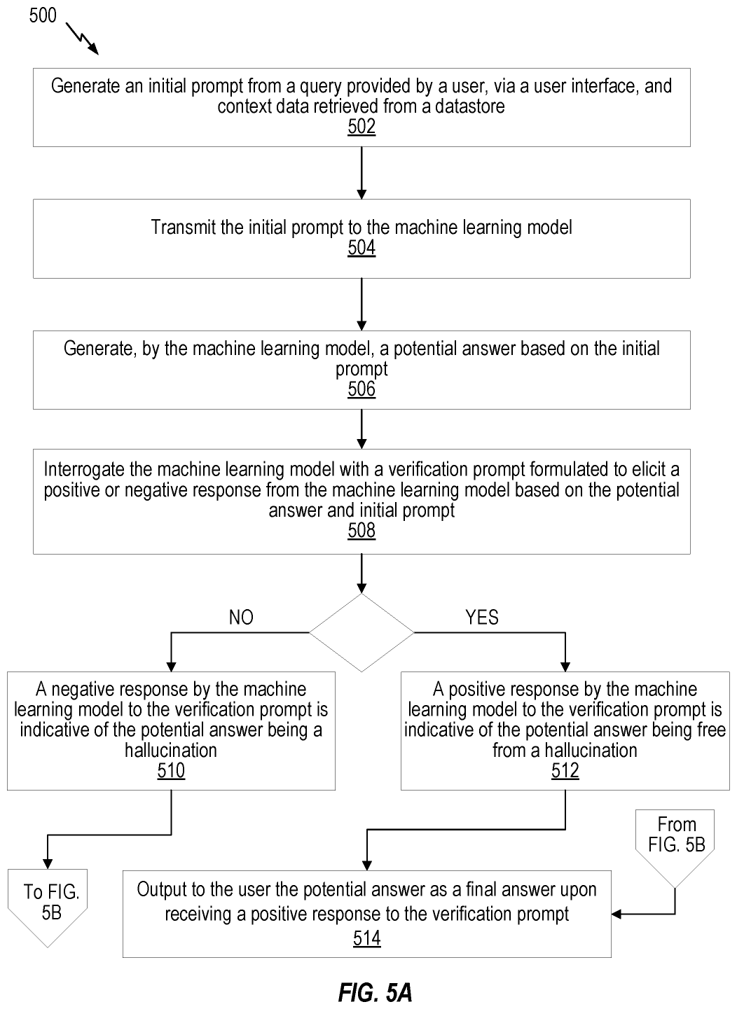

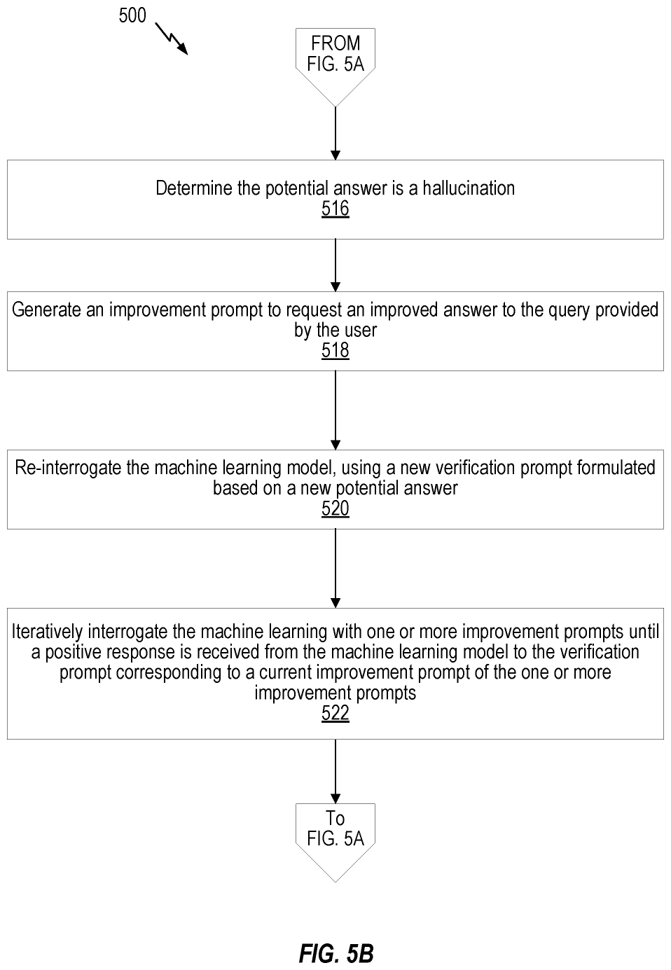

FIGS. 5A and 5B illustrates a flow representation of an example method 500 for performing aspects of the present disclosure. The method 500 begins, at step 502, where the method generates an initial prompt (e.g., 116 in FIG. 1) from a query (e.g., 108 in FIG. 1) provided by the user via the user interface (e.g., 106 in FIG. 1) and context data (e.g., 110 in FIG. 1) retrieved from a datastore (e.g., 112 in FIG. 1). The method 500 transmits the initial prompt 116, at step 504, to a machine learning model (e.g., 118 in FIG. 1). The method 500 generates a potential answer (e.g., 120 in FIG. 1) at step 506. The method 500, at step 508, interrogates the machine learning model 118 with a verification prompt (e.g., 124 in FIG. 1) formulated to elicit a positive or negative response from the machine learning model 118 based on the potential answer 120 and the initial prompt 116.

A positive response, at step 512, by the machine learning model 118 to the verification prompt 124 is indicative of the potential answer 120 being free from hallucinations, and thus, causes the method to proceed to step 514. The method 500 outputs to the user a final answer (e.g., 130 in FIG. 1) generated from the potential answer 120 determined to be free from hallucinations at step 514.

Alternatively, a negative response, at step 510, by the machine learning model 118 to the verification prompt 124 is indicative of the potential answer 120 being a hallucination, and thus, causes the method to proceed from step 510 to step 516 (depicted and described in more detail with respect to FIG. 5B).

At step 516, the method 500 determines the potential answer 120 is a hallucination. The method 500 generates, at step 518, an improvement prompt (e.g., 128 in FIG. 1) to request an improved answer to the query 108 provided by the user. The method 500 advances from step 518 to step 520, where the method 500 re-interrogates the machine learning model 118, using a new verification prompt 124 formulated based on a new potential answer 120 generated by the machine learning model 118 in response to the improvement prompt 128. The method 500, at step 522, iteratively interrogates the machine learning model 118 with one or more improvement prompts 128 until a positive response is received from the machine learning model 118 to the verification prompt 124 corresponding to the improvement prompt 128. The method 500 continues to perform step 522 until a positive response is received to the latest verification prompt 124, at which point the method 500 returns to step 514 and outputs the final answer 130 to the user.

Note that FIGS. 5A and 5B are just examples of methods, and other methods including fewer, additional, or alternative steps are possible consistent with this disclosure. For example, in some embodiments, the initial prompt includes, in addition to the query and context data, instructions (114 in FIG. 1) configured to instruct the machine learning model 118 on parameters and formatting of the final answer responsive to the initial prompt. In some embodiments, the verification prompt includes verification instructions configured to instruct the machine learning model to assume a role of a classifier directed to classify whether the potential answer is strictly derived from the context data. In some embodiments, the improvement prompt includes improvement instructions configured to reduce a probability of a hallucination in the final answer.

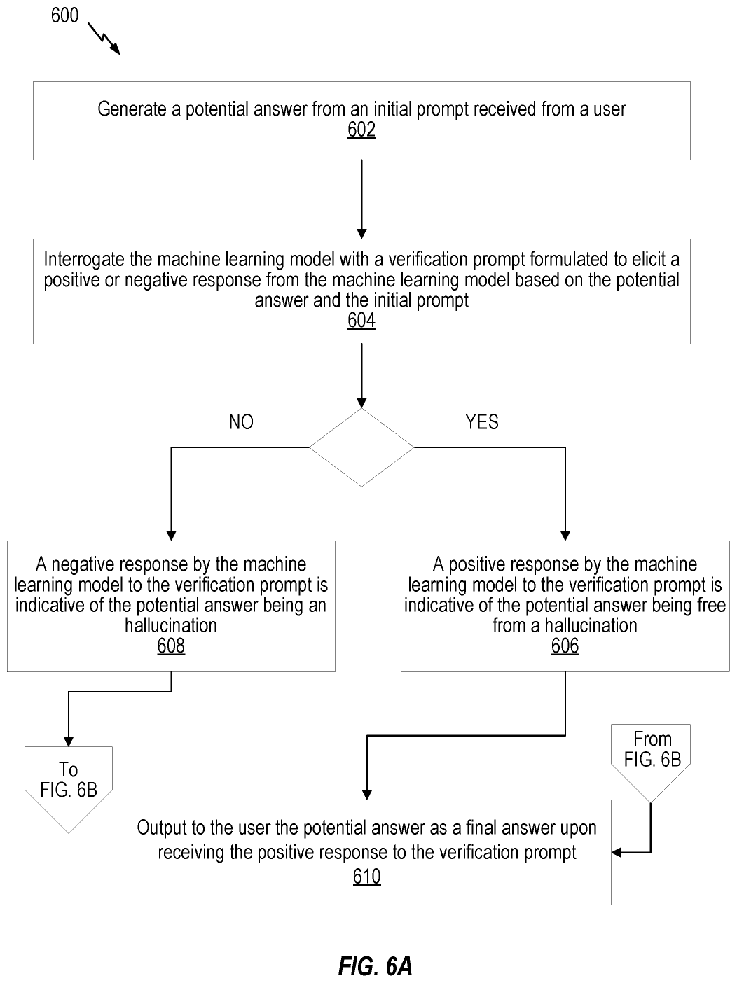

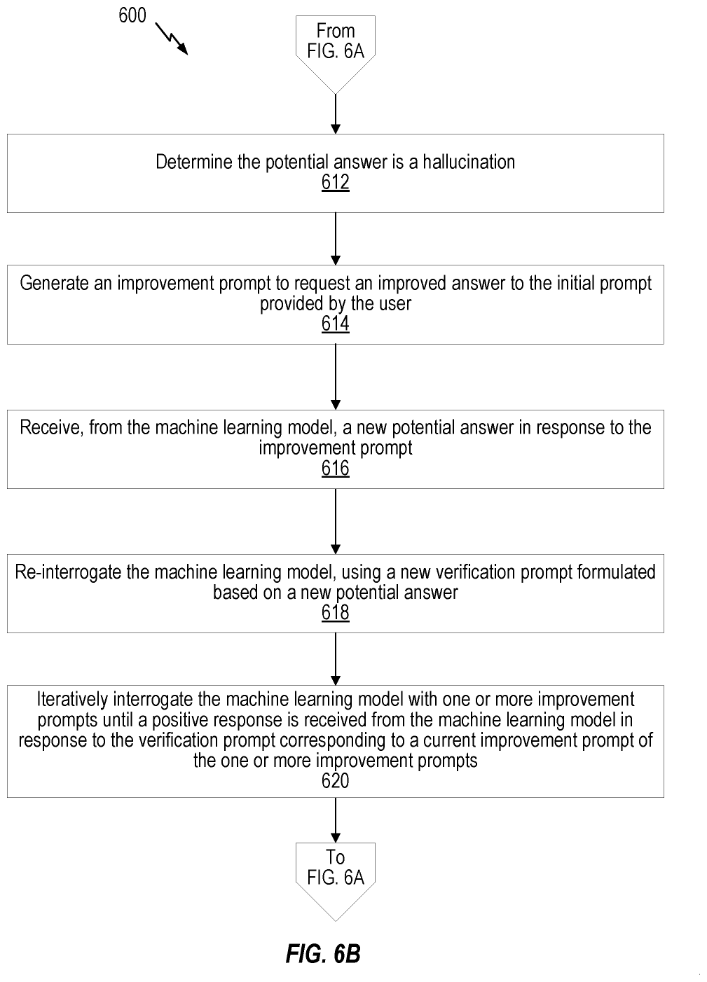

FIGS. 6A and 6B illustrates a flow representation of an example method 600 for performing aspects of the present disclosure. The method 600 begins, at step 602, where the method 600 generates a potential answer (e.g., 120 in FIG. 1) by a machine learning model (e.g., 118 in in FIG. 1) from an initial prompt (e.g., 116 in FIG. 1) received from a user. The method 600 interrogates the machine learning model 118 with a verification prompt (e.g., 124 in FIG. 1) formulated to elicit a Yes or No (or other positive or negative) response from the machine learning model 118 based on the potential answer 120 and initial prompt 116 at step 604. The method 600 continues to step 606, when a YES (positive) response is received or step 608 when a NO (negative) response is received.

A positive response by the machine learning model 118 to the verification prompt 124 is indicative of the potential answer 120 being free from hallucinations, and thus, causes the method 600 to proceed from step 606 to step 610. The method 600 outputs to a user the potential answer 120 as a final answer (e.g., 130 in FIG. 1) upon receiving the positive response to the verification prompt 124 at step 610.

Alternatively, a negative response by the machine learning model 118 to the verification prompt 124 is indicative of the potential answer 120 being a hallucination, and thus, causes the method to proceed from step 608 to step 612 (shown in FIG. 6B). At step 612, the method 600 determines the potential answer 120 is a hallucination. The method 600 generates an improvement prompt (e.g., 128 in FIG. 1) to request an improved answer to the initial prompt 116 provided by the user, at step 614. The method 600 advances from step 614 to step 616, where the method 600 re-interrogates the machine learning model 118, using a new verification prompt 124 formulated based on a new potential answer 120 generated by the machine learning model 118 in response to the improvement prompt 128. The method 600, at step 618, iteratively interrogates the model 118 with one or more improvement prompts 128 until a positive response is received from the machine learning model 118 to the verification prompt 124 corresponding to the improvement prompt 128. The method 600 continues to perform step 618 until a positive response is received to the latest verification prompt 124, at which point the method 600 returns to step 610 and outputs the final answer 130 to the user.

Note that FIGS. 6A and 6B are just examples of methods, and other methods including fewer, additional, or alternative steps are possible consistent with this disclosure. For example, in some embodiments, the initial prompt 116 may include a query (e.g., 108 in FIG. 1) submitted by the user posing a question to be answered by the machine learning model 118, instructions (e.g., 114 in FIG. 1) configured to instruct the machine learning model 118 on parameters and formatting of the potential answer 120 responsive to the initial prompt 116, and context data (e.g., 110 in FIG. 1) from which the potential answer 120 is to be derived. In some embodiments, the context data 110 includes one or more of: an article, a website universal resource locator (URL), a database or a combination thereof. In some embodiments, the verification prompt 124 includes verification instructions (e.g., 123 in FIG. 1) configured to instruct the machine learning model to assume a role of a classifier directed to classify whether the potential answer is derived from the context data 110. In some embodiments, the improvement prompt 128 includes improvement instructions (e.g., 127 in FIG. 1) configured to reduce a probability of a hallucination in the final answer 130.

### Example Processing System for Detecting Hallucinations in a Machine Learning Model

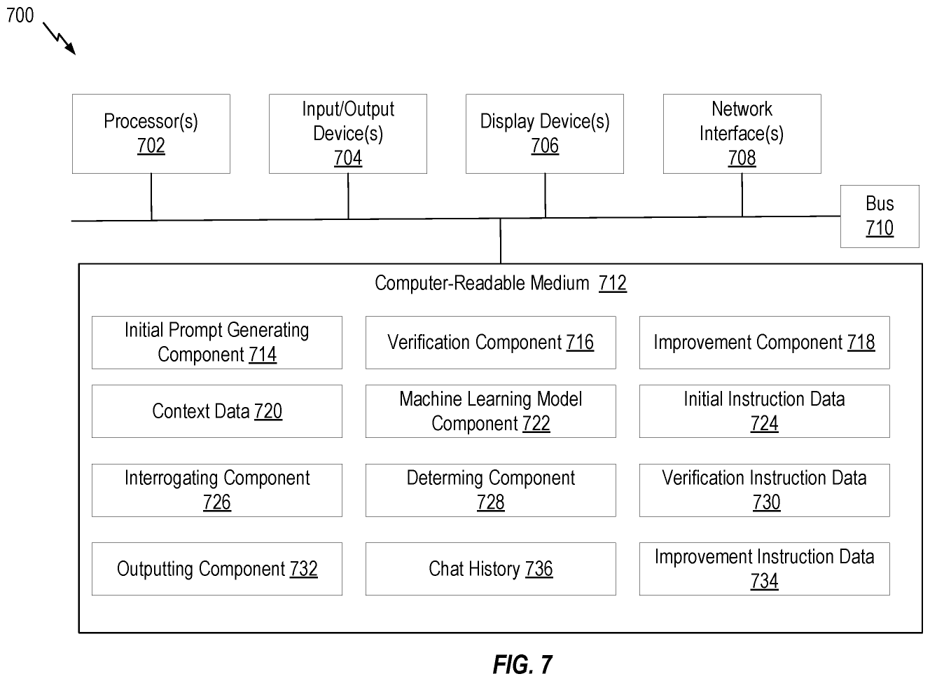

FIG. 7 depicts a block representation of an example processing system 700 configured to perform various aspects described herein, including, for example, the method 200, the method 300, the method 400, the method 500 and the method 600 described above with respect to FIG. 2, FIG. 3, FIG. 4, FIGS. 5A-5B, and FIGS. 6A-6B, respectively.

Processing system 700 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 700 includes one or more processors 702, one or more input/output devices 704, one or more display devices 706, and one or more network interfaces 708 through which processing system 700 is connected to one or more networks (e.g., a local network, an intranet, the Internet, or any other group of processing systems communicatively connected to each other), and computer-readable medium 712.

In the depicted example, the aforementioned components are coupled by a bus 710, which may generally be configured for data and/or power exchange amongst the components. Bus 710 may be representative of multiple buses, while only one is depicted for simplicity.

Processor(s) 702 are generally configured to retrieve and execute instructions stored in one or more memories, including local memories like the computer-readable medium 712, as well as remote memories and data stores. Similarly, processor(s) 702 are configured to retrieve and store application data residing in local memories like the computer-readable medium 712, as well as remote memories and data stores. More generally, bus 710 is configured to transmit programming instructions and application data among the processor(s) 702, display device(s) 706, network interface(s) 708, and computer-readable medium 712. In certain embodiments, processor(s) 702 are included to be representative of a one or more central processing units (CPUs), graphics processing unit (GPUs), tensor processing unit (TPUs), accelerators, and other processing devices.

Input/output device(s) 704 may include any device, mechanism, system, interactive display, and/or various other hardware components for communicating information between processing system 700 and a user of processing system 700. For example, input/output device(s) 704 may include input hardware, such as a keyboard, touch screen, button, microphone, and/or other device for receiving inputs from the user. Input/output device(s) 704 may further include display hardware, such as, for example, a monitor, a video card, and/or other another device for sending and/or presenting visual data to the user. In certain embodiments, input/output device(s) 704 is or includes a graphical user interface.

Display device(s) 706 may generally include any sort of device configured to display data, information, graphics, user interface elements, and the like to a user. For example, display device(s) 706 may include internal and external displays such as an internal display of a tablet computer or an external display for a server computer or a projector. Display device(s) 706 may further include displays for devices, such as augmented, virtual, and/or extended reality devices.

Network interface(s) 708 provide processing system 700 with access to external networks and thereby to external processing systems. Network interface(s) 708 can generally be any device capable of transmitting and/or receiving data via a wired or wireless network connection. Accordingly, network interface(s) 708 can include a communication transceiver for sending and/or receiving any wired and/or wireless communication. For example, Network interface(s) 708 may include an antenna, a modem, a LAN port, a Wi-Fi card, a WiMAX card, cellular communications hardware, near-field communication (NFC) hardware, satellite communication hardware, and/or any wired or wireless hardware for communicating with other networks and/or devices/systems. In certain embodiments, network interface(s) 708 includes hardware configured to operate in accordance with the Bluetooth® wireless communication protocol.

Computer-readable medium 712 may be a volatile memory, such as a random access memory (RAM), or a nonvolatile memory, such as nonvolatile random access memory, phase change random access memory, or the like. In this example, computer-readable medium 712 includes an initial prompt component 714, a verification component 716 (e.g., verification logic 122 in FIG. 1), an improvement component 718 (e.g., improvement logic 126 in FIG. 1), a machine learning model component 722 (e.g., machine learning model 118 in FIG. 1), an interrogating component 726, a determining component and an outputting component 732. Additionally, the computer-readable medium 712 includes various data as well, for example, context data 720 (e.g., context data 110 in FIG. 1), initial instruction data 724 (e.g., instructions 114 in FIG. 1), verification instruction data 730 and improvement instruction data 734.

In certain embodiments, initial prompt generating component 714 is configured to receive a query (query 108 in FIG. 1) submitted by a user via the input/output device 704 and generate an initial prompt, such as initial prompt 116, as described above with respect to, for example, FIG. 4. The initial prompt generating component 714 combines the query 108 with instructions 114 obtained from the initial instruction data 724 and context data 720 and chat history 736. The chat history 736, is a record of all the answers, such as potential answer 120 in FIG. 1, for example, generated by the machine learning model component 722 in the course of responding to an initial prompt 116. Additionally, the chat history 736 may include a record of improvement prompts (e.g., improvement prompt 128 in FIG. 1) generated by the improvement component 718.

In certain embodiments, machine learning model component 722 receives the initial prompt 116 generated by the initial prompt generating component 714. The machine learning model component 722 processes the initial prompt 116 and generates an answer, such as the potential answer 120.

In certain embodiments, the verification component 716 receives the potential answer 120 from the machine learning model 722. The verification component 716 generates a verification prompt 124, as described above with respect to FIG. 4. The verification prompt 124 includes verification instructions form the verification instruction data 730. In certain embodiments, the verification component 716 is an example of a verification logic 122 in FIG. 1.

In certain embodiments, the interrogating component 726 submits the verification prompt 124 to the machine learning model component 722 for evaluation. In certain embodiments, the interrogating component 726 is an example component logic of the verification logic 122 in FIG. 1. The machine learning model component 722 provides either a “YES” or “NO” response, resulting from the verification prompt 124, to the determining component 728. As described above, with respect to FIG. 4, the interrogating component 726 may iteratively interrogate the machine learning model component 722 with new verification prompts 124 each time the machine learning model component 722 returns a “NO” response until a potential answer 120 results in a “YES” response. In certain embodiments, the determining component 728 determines whether the potential answer 120 is the result of a hallucination or not based on the “YES” or “NO” response.

In certain embodiments, determining component 728 determines a “YES” response as signifying that the potential answer 120 is free of hallucinations, and determines a “NO” response as signifying that the potential answer 120 is the result of hallucinations. In certain embodiments, the determining component 716 is an example component logic of the verification logic 122 in FIG. 1.

In certain embodiments, the improvement component 718 is triggered by the determining component 728 when the determining component 728 determines that the potential answer 120 is the result of hallucinations. The improvement component 718 generates an improvement prompt 128, as described above with respect to FIG. 4. The improvement prompt 128 is submitted to the machine learning model component 722 for evaluation. The improvement prompt 128 generated by the improvement component 718 includes improvement instructions from the improvement instruction data 734 that tunes the initial prompt 116 to reduce the probability of a hallucination occurring. In certain embodiments, the improvement component 716 is an example of the improvement logic 126 in FIG. 1.

In certain embodiments, the outputting component receives the potential answer 120 that has been interrogated by the interrogating component 726 and determined to be free of hallucinations by the determining component 728. The outputting component 732 prepares the potential answer for transmission to the user as a final answer 130. The user may receive the final answer 130 via the input/output device 704, the display device 706, or at a remote location via the network interface 708.

Note that FIG. 7 is just one example of a processing system consistent with aspects described herein, and other processing systems having additional, alternative, or fewer components are possible consistent with this disclosure.

### Example Clauses

Implementation examples are described in the following numbered clauses:

Clause 1: A method for detecting hallucinations in output from a machine learning model, the method comprising: generating a potential answer from an initial prompt received from a user; interrogating the machine learning model with a verification prompt formulated to elicit a positive or negative response from the machine learning model based on the potential answer and initial prompt, wherein: a negative response by the neural network model to the verification prompt is indicative of the potential answer being a hallucination, and a positive response by the machine learning model to the verification prompt is indicative of the potential answer being free from a hallucination; and outputting to the user the potential answer as a final answer upon receiving the positive response to the verification prompt.

Clause 2: The method as in Clause 1, wherein the initial prompt includes: a query submitted by a user posing a question to be answered by the machine learning model; instructions configured to instruct the machine learning model on parameters and formatting of the potential answer responsive to the initial prompt; and context data from which the potential answer is to be derived.

Clause 3: The method as in Clause 2, wherein the context data includes one or more of: an article, a website universal resource locator (URL), a database or a combination thereof.

Clause 4: The method as in any one of Clauses 2 and 3, wherein the verification prompt includes verification instructions configured to instruct the machine learning model to assume the role of a classifier directed to classify whether the potential answer is derived from the context data.

Clause 5: The method as in any one of Clauses 1-4, further comprising: determining, based on receiving a negative responsive to the verification prompt, the potential answer is a hallucination; generating an improvement prompt to request an improved answer to the initial prompt provided by the user; receiving, from the machine learning model, a new potential answer in response to the improvement prompt; and re-interrogating the machine learning model, using a new verification prompt formulated based on the new potential answer.

Clause 6: The method as in Clause 5, further comprising iteratively interrogating the machine learning model with one or more improvement prompts until a positive response is received from the machine learning model in response to the verification prompt corresponding to a current improvement prompt of the one or more improvement prompts.

Clause 7: The method as in any one of Clauses 5 and 6, wherein the improvement prompt includes improvement instructions configured to reduce a probability of a hallucination in the final answer.

Clause 8: A method for detecting hallucinations in a machine learning model, the generating an initial prompt from a query provided by a user, via a user interface, and context data retrieved from a datastore; transmitting the initial prompt to the machine learning model; generating, by the machine learning model, a potential answer based on the initial prompt; interrogating the machine learning model with a verification prompt formulated to elicit a positive or negative response from the machine learning model based on the potential answer and initial prompt, wherein: a negative response by the machine learning model to the verification prompt is indicative of the potential answer being a hallucination, and a positive response by the machine learning model to the verification prompt is indicative of the potential answer being free from a hallucination; and outputting to the user the potential answer as a final answer upon receiving a positive response to the verification prompt.

Clause 9: The method as in Clause 8, wherein the initial prompt further comprises instructions configured to instruct the machine learning model on parameters and formatting of the final answer responsive to the initial prompt.

Clause 10: The method as in Clause 9, wherein the verification prompt includes verification instructions configured to instruct the machine learning model to assume a role of a classifier directed to classify whether the potential answer is strictly derived from the context data.

Clause 11: The method as in any one of Clauses 8-10, further comprising: determining, based on receiving a negative responsive to the verification prompt, the potential answer is a hallucination; generating an improvement prompt to request an improved answer to the query provided by the user; and re-interrogating the machine learning model, using a new verification prompt formulated based on a new potential answer.

Clause 12: The method as in Clause 11, further comprising iteratively interrogating the machine learning with one or more improvement prompts until a positive response is received from the machine learning model to the verification prompt corresponding to a current improvement prompt of the one or more improvement prompts.

Clause 13: The method as in any one of Clauses 11 and 12, wherein the improvement prompt includes improvement instructions configured to reduce a probability of a hallucination in the final answer.

Clause 14: A processing system, comprising: one or more memory comprising computer-executable instructions; and one or more processors configured to execute the computer-executable instructions and cause the processing system to perform a method in accordance with any one of Clauses 1-13.

Clause 15: A processing system, comprising means for performing a method in accordance with any one of Clauses 1-13.

Clause 15: A non-transitory computer-readable medium storing program code for causing a processing system to perform the steps of any one of Clauses 1-13.

Clause 16: A computer program product embodied on a computer-readable storage medium comprising code for performing a method in accordance with any one of Clauses 1-13.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for detecting hallucinations in output from a machine learning model, the method comprising:
generating a potential answer from an initial prompt received from a user;
interrogating the machine learning model with a verification prompt formulated to elicit a positive or negative response from the machine learning model based on the potential answer and the initial prompt, wherein:
a negative response by the machine learning model to the verification prompt is indicative of the potential answer being a hallucination, and
a positive response by the machine learning model to the verification prompt is indicative of the potential answer being free from a hallucination; and
outputting to the user the potential answer as a final answer upon receiving the positive response to the verification prompt.

2. The method of claim 1, wherein the initial prompt comprises:
a query submitted by the user posing a question to be answered by the machine learning model;
instructions configured to instruct the machine learning model on parameters and formatting of the potential answer responsive to the initial prompt; and
context data from which the potential answer is to be derived.

3. The method of claim 2, wherein the context data includes one or more of: an article, a website universal resource locator (URL), a database or a combination thereof.

4. The method of claim 2, wherein the verification prompt includes verification instructions configured to instruct the machine learning model to assume a role of a classifier directed to classify whether the potential answer is derived from the context data.

5. The method of claim 1, further comprising:
determining, based on receiving a negative responsive to the verification prompt, the potential answer is a hallucination;
generating an improvement prompt to request an improved answer to the initial prompt provided by the user;
receiving, from the machine learning model, a new potential answer in response to the improvement prompt; and
re-interrogating the machine learning model, using a new verification prompt formulated based on the new potential answer.

6. The method of claim 5, further comprising iteratively interrogating the machine learning model with one or more improvement prompts until a positive response is received from the machine learning model in response to the verification prompt corresponding to a current improvement prompt of the one or more improvement prompts.

7. The method of claim 5, wherein the improvement prompt includes improvement instructions configured to reduce a probability of a hallucination in the final answer.

8. A system for detecting hallucinations in output from a machine learning model, the system comprising:
an interface configured to accept a query;
one or more memory comprising computer-executable instructions and a machine learning model;
one or more processors configured to execute the computer-executable instructions and causing the system to:
generate a potential answer from an initial prompt, and
interrogate the machine learning model with a verification prompt formulated to elicit a positive or negative response from the machine learning model based on the potential answer and initial prompt, wherein:
a negative response by the machine learning model to the verification prompt is indicative of the potential answer being a hallucination, and
a positive response by the machine learning model to the verification prompt is indicative of the potential answer being free from a hallucination; and
an output device configured to present to a user the potential answer as a final answer upon receiving a positive response to the verification prompt.

9. The system of claim 8, wherein the initial prompt comprises:
a query submitted by a user posing a question to be answered by the machine learning model;
instructions configured to instruct the machine learning model on parameters and formatting of the final answer responsive to the initial prompt; and
context data from which the potential answer is to be derived.

10. The system of claim 9, wherein the context data includes one or more of: an article, a website universal resource locator (URL), a database or a combination thereof.

11. The system of claim 9, wherein the verification prompt includes verification instructions configured to instruct the machine learning model to assume a role of a classifier directed to classify whether the potential answer is strictly derived from the context data.

12. The system of claim 8, wherein the one or more processors is further configured to cause the system to:
determine the potential answer is a hallucination;
generate an improvement prompt to request an improved answer to the query provided by a user; and
re-interrogate the machine learning model, using a new verification prompt formulated based on a new potential answer generated by the machine learning model in response to the improvement prompt.

13. The system of claim 12, wherein the one or more processors is further configured to cause the system to iteratively interrogate the machine learning model with one or more improvement prompts until a yes response is received from the machine learning model to the verification prompt corresponding to the improvement prompt.

14. The system of claim 12, wherein the improvement prompt includes improvement instructions configured to reduce a probability of a hallucination in the final answer.

15. A method for detecting hallucinations in a machine learning model, the method comprising:
generating an initial prompt from a query provided by a user, via a user interface, and context data retrieved from a datastore;
transmitting the initial prompt to the machine learning model;
generating, by the machine learning model, a potential answer based on the initial prompt;
interrogating the machine learning model with a verification prompt formulated to elicit a positive or negative response from the machine learning model based on the potential answer and initial prompt, wherein:
a negative response by the machine learning model to the verification prompt is indicative of the potential answer being a hallucination, and
a positive response by the machine learning model to the verification prompt is indicative of the potential answer being free from a hallucination; and
outputting to the user the potential answer as a final answer upon receiving a positive response to the verification prompt.

16. The method of claim 15, wherein the initial prompt further comprises instructions configured to instruct the machine learning model on parameters and formatting of the final answer responsive to the initial prompt.

17. The method of claim 16, wherein the verification prompt includes verification instructions configured to instruct the machine learning model to assume a role of a classifier directed to classify whether the potential answer is strictly derived from the context data.

18. The method of claim 15, further comprising:
determining, based on receiving a negative responsive to the verification prompt, the potential answer is a hallucination;
generating an improvement prompt to request an improved answer to the query provided by the user; and
re-interrogating the machine learning model, using a new verification prompt formulated based on a new potential answer.

19. The method of claim 18, further comprising iteratively interrogating the machine learning with one or more improvement prompts until a positive response is received from the machine learning model to the verification prompt corresponding to a current improvement prompt of the one or more improvement prompts.

20. The method of claim 18, wherein the improvement prompt includes improvement instructions configured to reduce a probability of a hallucination in the final answer.
